(19) United States
(12) Patent Application Publication
(10) Pub. No.: US 2026/0291807 A1
(43) Pub. Date: Sep. 24, 2026

(54) System and Method for Cross-Device User Experience Migration

(71) Applicant: T-Mobile Innovations LLC, Overland Park, KS (US)

(72) Inventors: Billy Gene McCracken, JR., Lenexa, KS (US); Jacob Fruehling, Renton, WA (US)

(21) Appl. No.: 19/572,831

(22) Filed: Mar. 19, 2026

Related U.S. Application Data
(60) Provisional application No. 63/775,018, filed on Mar. 20, 2025.

(51) Int. Cl. H04L 41/0803; G06F 8/61; H04L 67/306

(52) U.S. Cl. CPC H04L 41/0803; G06F 8/61; H04L 67/306

(57) ABSTRACT

A method comprising capturing, by a carrier application executing on a source device with system-level permissions, a plurality of device configuration parameters from a plurality of device settings modules of the source device to obtain a device settings file with the device configuration parameters formatted according to a device-agnostic configuration schema, storing the device settings file in association with a user profile at a profile management server of a carrier network, wherein the user profile is a persistent data structure associated with a user across a plurality of devices, and deploying the user profile, upon detection of a device activation event at a target device, by translating the device-agnostic configuration schema into target-specific configuration parameters compatible with the target device and applying the target-specific configuration parameters to the target device to reproduce the device experience of the source device at the target device.

### CROSS-REFERENCE TO RELATED APPLICATIONS

This application claims priority to U.S. Provisional Patent Application No. 63/775,018, filed Mar. 20, 2025, and entitled "METHODS AND SYSTEMS FOR CUSTOMER EXPERIENCE PROFILING," by Billy Gene McCracken, Jr., et al., which is incorporated herein by reference in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Mobile devices may accumulate hundreds of individual configuration settings spanning display settings, accessibility configurations, application arrangements, notification preferences, and communications settings, each encoded in platform-specific formats that are incompatible across device manufacturers and operating system versions. For example, such settings may include display settings such as font size, display brightness, and wallpaper configurations, accessibility configurations such as magnification settings and contrast preferences, and communications settings such as default application assignments and notification preferences per application.

### SUMMARY

In an embodiment, a system for cross-device user experience migration is disclosed. The system comprises a source device comprising a carrier application pre-installed on the source device that is configured to operate with system-level permissions assigned to the carrier application at a time of installation on the source device, in which the system-level permissions enable the carrier application to access and interrogate a plurality of device settings modules of the source device, and the carrier application is configured to capture a plurality of device configuration parameters from the plurality of device settings modules of the source device by invoking the system-level permissions, generate a device settings file by organizing the captured plurality of device configuration parameters into a device-agnostic configuration schema, in which the device-agnostic configuration schema encodes the plurality of device configuration parameters in a structured format that is independent of an operating system version, a manufacturer-specific software layer, or a hardware configuration of the source device, and transmit the device settings file to a profile management server of a carrier network, in which the profile management server is configured to receive and store the device settings file in association with a user profile of a user. The user profile is a persistent data structure associated with the user across a plurality of devices comprising the source device and one or more target devices, and the user profile aggregates device settings files derived from the plurality of devices over time. The system further comprises a target device comprising a deployment application configured to retrieve the user profile from the profile management server, translate the device-agnostic configuration schema of the user profile into target-specific configuration parameters compatible with a hardware configuration and a software configuration of the target device, and apply the target-specific configuration parameters to the target device to reproduce a device experience of the source device at the target device.

In another embodiment, a method for cross-device user experience migration in a carrier network system is disclosed. The method comprises capturing, by a carrier application executing on a source device with system-level permissions unavailable to third-party applications executing on the source device, a plurality of device configuration parameters from a plurality of device settings modules of the source device, generating, by the carrier application, a device settings file by organizing the captured plurality of device configuration parameters into a device-agnostic configuration schema, in which the device-agnostic configuration schema encodes the plurality of device configuration parameters in a structured format that is independent of an operating system version, a manufacturer-specific software layer, or a hardware configuration of the source device, transmitting, by the carrier application, the device settings file to a profile management server of a carrier network for storage in association with a user profile of a user, in which the user profile is a persistent data structure associated with the user across a plurality of devices comprising the source device and one or more target devices, receiving, by a deployment application executing at a target device, the user profile from the profile management server upon detection of a device activation event at the target device, translating, by the deployment application, the device-agnostic configuration schema of the user profile into target-specific configuration parameters compatible with a hardware configuration and a software configuration of the target device, and applying, by the deployment application, the target-specific configuration parameters to the target device to reproduce the device experience of the source device at the target device.

In yet another embodiment, a non-transitory computer-readable medium comprising instructions that, when executed by one or more processors, cause the one or more processors to capture, by a carrier application executing on a source device with system-level permissions, a plurality of device configuration parameters from a plurality of device settings modules of the source device to obtain a device settings file with the device configuration parameters formatted according to a device-agnostic configuration schema, store the device settings file in association with a user profile at a profile management server of a carrier network, in which the user profile is a persistent data structure associated with a user across a plurality of devices, and deploy the user profile, upon detection of a device activation event at a target device, by translating the device-agnostic configuration schema into target-specific configuration parameters compatible with the target device and applying the target-specific configuration parameters to the target device to reproduce the device experience of the source device at the target device.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a cross-device user experience migration system according to various embodiments of the disclosure.

FIG. 2 is a diagram illustrating a method for obtaining device configuration parameters from a source device according to various embodiments of the disclosure.

FIG. 3 is a message sequence diagram illustrating a method for deploying a user profile to a target device in the cross-device user experience migration system of FIG. 1 according to various embodiments of the disclosure.

FIG. 4 is a message sequence diagram illustrating a method for initiating a temporary carrier provisioning session on a source device in the cross-device user experience migration system of FIG. 1 according to various embodiments of the disclosure.

FIG. 5 is a flowchart illustrating a method for cross-device user experience migration in a carrier network system according to various embodiments of the present disclosure.

FIG. 6 is a flowchart illustrating a method for cross-device user experience migration executed by one or more processors according to various embodiments of the present disclosure.

FIG. 7 is a block diagram of a computer system implemented within the communication system of FIG. 1 according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

When a subscriber migrates from one mobile device to another, the process of reproducing the device experience of the source device at the target device may be technically complex. Mobile devices may operate across heterogeneous ecosystems with devices from multiple manufacturers, running varying operating system versions, each implementing manufacturer-specific software layers and proprietary configuration architectures. Some migration solutions may be constrained to operate within a single manufacturer ecosystem, relying on device-specific backup protocols that may be incompatible across heterogeneous configurations. Furthermore, applications operating at the standard application permission tier may be denied access to system-level device settings modules, rendering third-party migration tools technically incapable of capturing a complete configuration state of the source device. These solutions may also generate point-in-time, device-specific backup archives that are not maintained as persistent, user-centric data structures aggregated across a subscriber's full device history.

These technical constraints may result in significant resource waste and system inefficiency during device transition events. A subscriber may be without access to a fully configured device for an extended period of time following activation of a target device, as device configuration parameters may need to be manually re-entered during and after the out-of-box experience procedure. During this period, the subscriber may experience degraded network connectivity, including dropped calls and interrupted data sessions, as communications settings, default application assignments, and notification preferences may not yet be correctly configured at the target device. The reconfiguration process may consume unnecessary processing resources, storage bandwidth, and network transmission overhead at both the target device and the carrier network infrastructure, introducing avoidable latency and redundant processing overhead that may persist well beyond the initial device activation event.

The present disclosure addresses the aforementioned technical problems in the technical field of cross-device user experience migration and carrier network profile management by providing a system and method in which a carrier application pre-installed on a source device with system-level permissions may capture a complete set of device configuration parameters from system-level device settings modules that may be inaccessible to third-party applications. The captured parameters may be organized and encoded into a device-agnostic configuration schema encoded in a device settings file that is independent of the operating system version, manufacturer-specific software layer, and hardware configuration of the source device. The device settings file may be transmitted to a profile management server and aggregated into a persistent user profile associated with the subscriber across multiple devices. A deployment application at a target device may retrieve, translate, and apply the user profile during initial device activation.

The cross-device user experience migration system may include a source device, a carrier network system, and a target device. The carrier network system may include a profile management server having access to a carrier data store. The carrier network system may include or be communicatively coupled to a data model system. The profile management server may include a management application configured to manage the lifecycle of user profiles stored in the data store. The management application may create, update, retrieve, and enrich user profiles in response to device settings files received from carrier applications running at the devices and predictive configuration recommendations generated by the data model system. The source device may include the carrier application, one or more device settings modules, a local data store, and a number of other installed applications. The target device may similarly include a deployment application, multiple device settings modules, a local data store, and other installed applications. Both the source device and the target device may be communicatively coupled to the carrier network system via the carrier network.

The carrier application may refer to a software application pre-installed on the source device by the carrier network operator at the time of device manufacturing. The carrier application may be assigned system-level permissions at the time of installation that enable it to access and interrogate the restricted device settings modules of the source device. These system-level permissions may place the carrier application in a privileged system application permission tier that is distinct from the standard application permission tier under which third-party applications operate. Under the standard permission tier, applications may be denied direct access to system-level device settings modules, including the display settings module, the application management module, the accessibility settings module, the notification management module, and the communications settings module. However, by operating at the privileged tier, the carrier application may invoke system-level application programming interfaces (APIs) to directly capture device configuration parameters stored within each of the device settings modules. These parameters may include, for example, application spatial placement data defining, for each application installed on the source device, a display page identifier, a grid position, and/or a folder association on the display interface. The parameters may further include home screen layout data, application tray configuration settings, display brightness settings, font size settings, magnification settings, sound level settings, volume profiles, notification preferences per application, default application assignments, battery optimization settings, lock screen configurations, wallpaper settings, and/or accessibility feature configurations.

The carrier application may retrieve the device configuration parameters from each of the device settings modules, and aggregate these parameters into a device settings file (e.g., sometimes referred to herein as a metadata file). The device settings file may refer to a structured data artifact generated by the carrier application by organizing the captured device configuration parameters into a device-agnostic configuration schema. The device-agnostic configuration schema may encode the device configuration parameters in a normalized, structured format that is independent of the operating system version, manufacturer-specific software layer, and hardware configuration of the source device. For example, the schema may organize the parameters into standardized configuration records, in which each record may include a parameter identifier, a parameter value, a parameter category, and, where applicable, a spatial placement attribute defining the position of an associated application on the display interface of the source device. By encoding the parameters in this manner, the device settings file may serve as a portable, manufacturer-neutral intermediate representation of the device experience that may be translated into target-specific configuration parameters compatible with a target device of any manufacturer, operating system version, or hardware configuration.

The carrier application may transmit the device settings file to the profile management server periodically or intermittently according to a predefined schedule. In an embodiment, the carrier application may sample the device configuration parameters at scheduled intervals and may update the device settings file at the profile management server only upon detecting that a threshold number of parameters have changed since the prior sampling event, thereby reducing unnecessary network transmission overhead. The carrier application may store the device settings file in a user profile associated with a user of the source device. For example, the carrier network system may maintain subscriber data across one or more network components, including a home subscriber server, a customer relationship management system, or a subscriber data repository. This subscriber data may include, for example, account identifiers, device activation history, service plan configurations, network usage records, and roaming history associated with the subscriber. The profile management server may access this subscriber data to supplement the user profile with carrier-maintained subscriber attributes, enabling the user profile to reflect both the device experience of the source device and the broader service history of the user within the carrier network.

The user profile may refer to a persistent, user-centric data structure maintained by the profile management server and associated with a subscriber across multiple devices. Unlike device-specific backup archives, the user profile may aggregate device settings files derived from all devices associated with the user over time. For example, management application may receive device settings files transmitted by the carrier application and may associate them with the corresponding user profile, maintaining it as a living data structure that may be updated upon each new or modified device settings file transmission. The user profile may further include preference data derived by the management application, which may be obtained by evaluating the device configuration parameters encoded in the device settings file (in some cases, using a machine learning model at the data model system), or retrieved from a subscriber data repository or customer relationship management system maintained by the carrier network. For example, the device configuration parameters may include one or more of a volume preference indicator from sound level settings, a visual accessibility preference indicator from font size or display contrast settings, or an interest category preference indicator from folder names or application groupings on the display interface. The management application may infer certain qualities or characteristics of the user based on these types of device configuration parameters (e.g., hearing necessities, visual necessities, general health conditions, etc.). This preference data may be stored in association with the user profile and may be made available to the data model system for use in generating predictive configuration recommendations.

The user profile may also include predicted configuration recommendations including recommendations for additional applications that the user may likely be interested in downloading and interacting with based on an activity history of the user and a recommended placement location of the recommended applications (e.g., indicating where on the display or what folder to include the recommended application). The management application may generate the predicted configuration recommendations in some cases using the data model system.

The data model system may refer to a server-side computational system in communication with or within the carrier network. The data model system may include one or more machine learning models trained on training data, which may be received from the profile management server or another entity associated with the carrier network. The training data may include, for example, user profiles aggregated across multiple subscribers of the carrier network, as well as a current user activity record associated with the user (e.g., reflecting historical usage patterns, application interaction data, and/or configuration preferences over time). The machine learning models may be trained to identify correlations between user activity records, device configuration parameters, preference data, and/or application usage patterns across the carrier network user base. Based on these correlations, the machine learning models may generate, for a given subscriber, a predictive configuration recommendation identifying one or more applications that the user may be predicted to be interested in. As mentioned above, the predictive configuration recommendation may specify, for each predicted application, a recommended application identity and a recommended placement location on the display interface of the target device (e.g.,) at least a target display page identifier, a target grid position, and a target folder association. The management application may supplement the user profile with the predictive configuration recommendation prior to deployment, such that the deployment application may present these recommendations to the user upon completion of the configuration migration. A user activity record provided to the data model system may include telemetry data with on-device behavioral signals, network and billing layer usage records, and, in some embodiments, advertising intelligence signals passively collected by the carrier network system 106.

Upon detection of a device activation event at the target device 109, a deployment application running at the target device may retrieve the user profile from the profile management server. The deployment application may refer to a software application configured to execute at the target device upon detection of a device activation event. The device activation event may be, for example, an out-of-box experience (OOBE) procedure triggered by detection of a carrier provisioning signal transmitted by the carrier network system upon activation of a SIM at the target device. Upon detection of this event, the deployment application may retrieve the user profile from the profile management server.

The deployment application may then translate the device-agnostic configuration schema into target-specific configuration parameters compatible with the hardware configuration and software configuration of the target device. For example, where the display grid configuration of the target device differs in dimensions from that of the source device, the deployment application may intelligently remap application spatial placement data by regrouping applications into folders, redistributing applications across display pages, or adjusting grid positions to preserve adjacency relationships between applications that were spatially associated on the source device. The deployment application may apply the target-specific configuration parameters prior to completion of the native device setup procedure, eliminating the processing overhead, storage bandwidth consumption, and user session time associated with manual reconfiguration.

In some embodiments, the carrier network system may initiate a temporary carrier provisioning session on a source device associated with a non-carrier network. For example, this may be accomplished by performing a SIM profile switch that temporarily associates the source device with the carrier network for a defined provisioning interval. During the provisioning interval, the carrier application may be installed on the source device as a privileged system application, enabling it to invoke the system-level permissions necessary to capture the device configuration parameters from the source device settings modules, as described above. Upon expiration of the provisioning interval, the carrier network system may revert the SIM profile of the source device to its prior association with the non-carrier network, imposing no persistent modification on the source device. For upgraded devices, the carrier network system may transmit a carrier profile activation signal to the source device causing carrier software to execute at the foreground, enabling capture without physical replacement of the SIM card. For other devices, the subscriber may be prompted to download a carrier profiling application prior to the provisioning interval, which may then be installed as a privileged system application upon session initiation.

This technical solution may directly address the aforementioned technical problems by reducing the processing resource overhead, storage bandwidth consumption, and user session time associated with device reconfiguration during device migration events in heterogeneous carrier network ecosystems. By employing a carrier application operating at the privileged system application permission tier, the system may achieve a technically comprehensive capture of the device experience of the source device that may not be achievable by migration applications operating at the standard permission tier. By encoding captured device configuration parameters in a device-agnostic configuration schema, the system may eliminate the interoperability failures arising from manufacturer-specific configuration formats, enabling cross-manufacturer and cross-operating-system migration without requiring device-specific translation protocols at the source device. By maintaining a persistent user profile that aggregates device settings files across several associated with the user over time, the system may eliminate the need for device-specific backup archives and may reduce network transmission overhead by replacing full-device imaging approaches with targeted, schema-normalized configuration snapshots transmitted only upon detection of threshold configuration changes.

By leveraging trained machine learning models at the carrier network infrastructure to generate predictive configuration recommendations based on aggregated user profiles and user activity records, including telemetry data collected across on-device, network, and billing layers, the system may further eliminate the computational burden and user session time associated with iterative manual application discovery at the target device. By deploying the user profile prior to completion of the native device setup procedure — which may be triggered automatically by a carrier provisioning signal upon SIM activation — the system may significantly reduce the latency and processing overhead associated with post-activation configuration, achieving near-instantaneous reproduction of the source device experience with minimal processing resource consumption at either the source device or the target device. These technical improvements may collectively reduce processing resource consumption, network transmission overhead, and configuration latency across the carrier network infrastructure, enabling efficient, automated, and intelligent device migration at scale across heterogeneous device ecosystems.

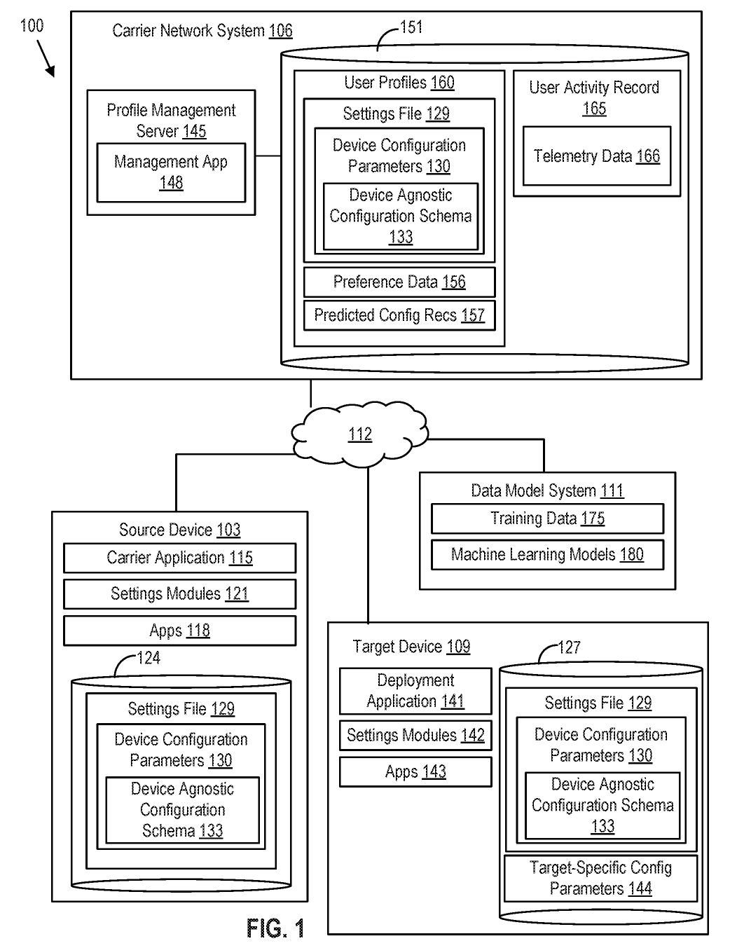

Turning now to FIG. 1, shown is a cross-device user experience migration system 100. The system 100 includes a source device 103, a carrier network system 106, a target device 109, and a data model system 111, each interconnected by network 112. The network 112 may be a communication network (e.g., a public network or a private network) enabling the source device 103, carrier network system 106, and target device 109 to securely and effectively communicate with one another. While the data model system 111 is shown as separate from the carrier network system 106 in FIG. 1, it should be appreciated that in some embodiments the carrier network system 106 may include the data model system 111.

The source device 103 may refer to a mobile device associated with a user (also referred to herein as “subscriber”) of the carrier network. In an embodiment, the source device 103 may also refer to any intelligent or internet-connected device capable of hosting the carrier application 115 and exposing configurable settings modules 121, including telecom devices, smartwatches, smart home controllers, or other connected devices within the user's device ecosystem. The source device 103 may be, for example, a smartphone, tablet, or other mobile computing device running any operating system version or manufacturer-specific software layer. As shown in FIG. 1, the source device 103 may include a carrier application 115, one or more settings modules 121, other installed applications 118, and a local data store 124.

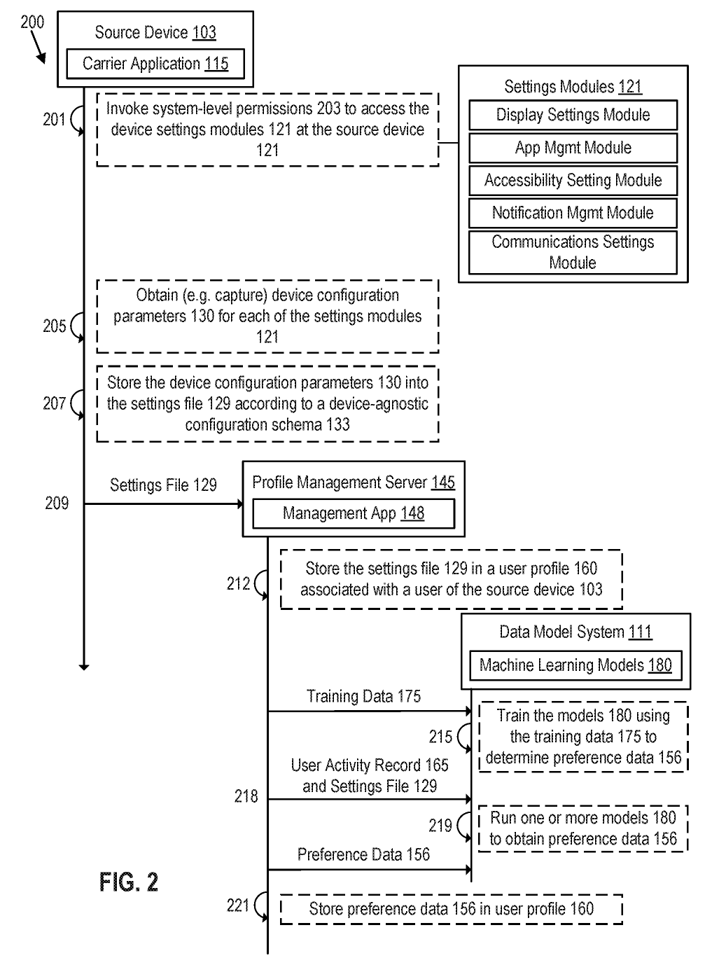

The carrier application 115 may refer to a software application pre-installed on the source device 103 by the carrier network operator at the time of device manufacturing. The carrier application 115 may be assigned system-level permissions at the time of installation, placing it in a privileged system application permission tier that is distinct from the standard application permission tier under which third-party applications operate. These system-level permissions may enable the carrier application 115 to invoke system-level APIs to directly access and interrogate the settings modules 121 of the source device 103. The carrier application 115 may be configured to obtain (e.g., receive, extract, capture) device configuration parameters 130 from each of the settings modules 121 and organize those parameters into a device settings file 129 encoded according to the device-agnostic configuration schema 133, as further described with respect to FIG. 2. The carrier application 115 may further be configured to transmit the device settings file 129 to the profile management server 145 periodically, intermittently, or upon detecting that a threshold number of device configuration parameters 130 have changed since a prior transmission.

The settings modules 121 may refer to a collection of system-level software modules executing on the source device 103 that manage distinct categories of device configuration. The settings modules 121 may include, for example, a display settings module, an application management module, an accessibility settings module, a notification management module, and a communications settings module. Each of the settings modules 121 may maintain a set of device configuration parameters 130 governing the behavior and appearance of the source device 103 within that module's category. Because the settings modules 121 operate at the system level, they may be inaccessible to applications operating at the standard application permission tier. The carrier application 115, by operating at the privileged tier, may directly interrogate each of the settings modules 121 to capture the complete set of device configuration parameters 130 stored with the settings modules 121, including parameters that may be unavailable to third-party migration applications. In an embodiment, the carrier application 115 may refer to a carrier tool firmware preloaded by the manufacturer (original equipment manager (OEM)) of the source device 103, which may have special system-level permissions that authorize management of the source device 103 and/or the applications 118.

The applications 118 may refer to the software applications installed on the source device 103 by the user. The applications 118 may include any combination of productivity applications, communication applications, media applications, navigation applications, or other software applications associated with the user’s device experience. In an embodiment, carrier application 115 may capture application spatial placement data associated with the applications 118 from the application management settings of the settings modules 121. For example, the application spatial placement data may include, for each application 118, a display page identifier, a grid position, and/or a folder association on the display interface of the source device 103. This spatial placement data may be encoded in the device settings file 129 and subsequently used by the deployment application 141 to reproduce the spatial arrangement of the applications 118 on a display interface of the target device 109.

The local data store 124 may refer to a storage component (e.g., one or more memories) of the source device 103 configured to store data generated by or associated with the carrier application 115. As shown in FIG. 1, the local data store 124 may store the device settings file 129 generated by the carrier application 115 prior to or in addition to its transmission to the profile management server 145. The device settings file 129 stored in the local data store 124 may include device configuration parameters 130 captured from the settings modules 121, organized according to the device-agnostic configuration schema 133. The device-agnostic configuration schema 133 may encode the device configuration parameters 130 in a normalized, structured format that is independent of the operating system version, manufacturer-specific software layer, and/or hardware configuration of the source device 103, enabling the device settings file 129 to be translated into target-specific configuration parameters 144 compatible with any target device 109 within the carrier network system 106 ecosystem.

The carrier network system 106 may refer to the infrastructure maintained and operated by the carrier network operator for managing subscriber accounts, device activations, and network services. As shown in FIG. 1, the carrier network system 106 may include a profile management server 145 and a carrier data store 151. The carrier network system 106 may be communicatively coupled to the source device 103 and the target device 109 via the network 112, enabling the profile management server 145 to receive device settings files 129 from the carrier application 115 and transmit user profiles 160 to the deployment application 141 upon detection of a device activation event at the target device 109. The carrier data store 151 may persistently store user profiles 160 and user activity records 165 associated with each subscriber, as further described below.

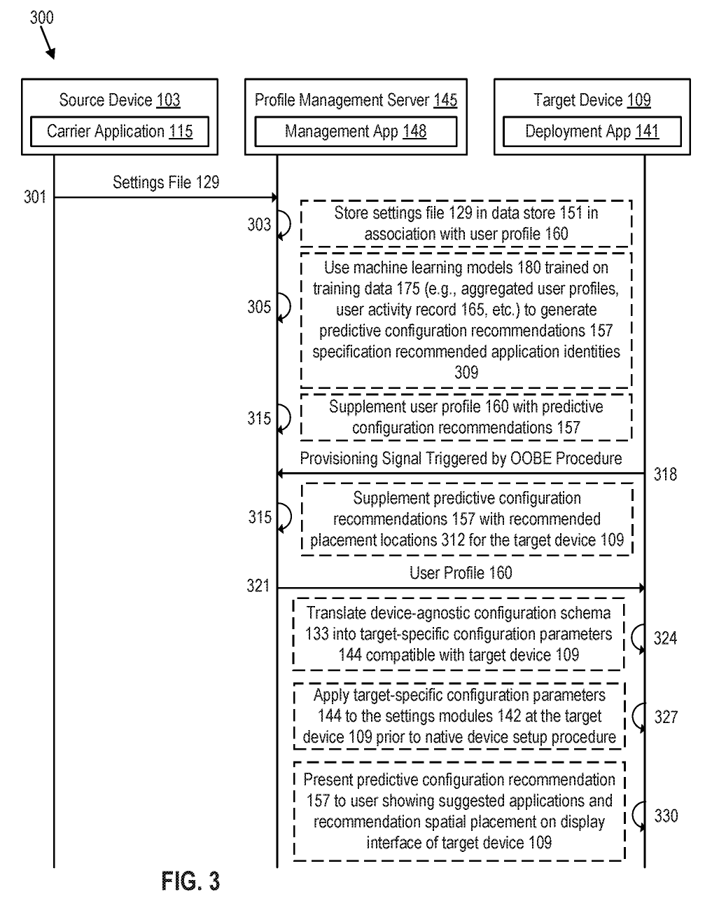

The profile management server 145 may refer to a server-side computing component of the carrier network system 106 configured to manage the user profiles 160 associated with users of the carrier network. The profile management server 145 may include a management application 148 configured to receive device settings files 129 transmitted by the carrier application 115, associate those files with the corresponding user profile 160, and maintain the user profile 160 as a living data structure that may be updated upon each new or modified device settings file 129 transmission. The management application 148 may further be configured to evaluate the device configuration parameters 130 encoded in the device settings file 129 to derive preference data 156 associated with the user. In some embodiments, the management application 148 may leverage the data model system 111 to analyze the device configuration parameters 130 in conjunction with user activity records 165, enabling the machine learning models 180 to identify inferred user preferences — such as accessibility needs, application usage tendencies, or content interest categories — that may not be directly ascertainable from the device configuration parameters 130 alone. The resulting preference data 156 may be stored in the user profile 160 and used by the data model system 111 as an input to the generation of predictive configuration recommendations 157. The profile management server 145 may further be configured to retrieve predictive configuration recommendations 157 generated by the data model system 111 and supplement the user profile 160 with those recommendations prior to deployment to the target device 109, as further described with respect to FIGS. 2 and 3.

The carrier data store 151 may refer to a storage component of the carrier network system 106 configured to persistently store data associated with subscribers of the carrier network across multiple devices over time. As shown in FIG. 1, the carrier data store 151 may store user profiles 160, each of which may include one or more device settings files 129 comprising device configuration parameters 130 captured from a device associated with the user and encoded according to the device-agnostic configuration schema 133. The carrier data store 151 may further store user activity records 165, preference data 156, and predicted configuration recommendations 157 associated with each subscriber, as further described below. The carrier data store 151 may be accessed by the management application 148 to retrieve and update user profiles 160 in response to device settings file 129 transmissions, user activity record 165 updates, and predictive recommendation generation events.

The user activity record 165 may refer to a persistent, carrier-maintained data structure associated with a subscriber of the carrier network that aggregates behavioral and usage signals collected from multiple sources over time. As shown in FIG. 1, the user activity record 165 may be stored in the carrier data store 151 and may be provided to the data model system 111 as an input to the machine learning models 180, as further described with respect to FIG. 2. The user activity record 165 may reflect a multi-source record of the subscriber's historical device usage and behavioral patterns that is not accessible to third-party applications or over-the-top migration tools operating outside of the carrier network infrastructure. The user activity record 165 may be continuously updated by the carrier network system 106 as new behavioral and usage signals are collected, maintaining it as a living data structure that reflects the subscriber's evolving device experience over time.

As shown in FIG. 1, the user activity record 165 may include telemetry data 166. The telemetry data 166 may refer to a collection of carrier-privileged behavioral and usage signals passively collected from one or more sources associated with the user, forming a core component of the user activity record 165. The telemetry data 166 may include on-device behavioral telemetry (e.g., application launch frequency, session duration per application, concurrent application usage patterns reflecting applications used simultaneously or in close sequence, and/or screen real estate data including the display page, grid position, and folder association of each application on the display interface of the source device 103). The telemetry data 166 may further include network and billing layer telemetry comprising carrier-maintained usage records, data consumption patterns, service plan interaction history, and/or roaming history associated with the subscriber and maintained by the carrier network system 106. In some embodiments, the telemetry data 166 may further include advertising intelligence signals comprising interaction data correlated to the user’s device and usage behavior, collected through carrier-affiliated advertising platforms and associated with the user’s account within the carrier network system 106. Because the telemetry data 166 may be collected simultaneously across on-device, network, billing, and/or advertising layers, the carrier network system 106 may have access to a multi-source behavioral signal set that is unavailable to third-party migration applications or device manufacturer backup systems operating outside of the carrier network infrastructure. The telemetry data 166 may be distinguished from device configuration parameters 130 captured by direct settings interrogation — rather than reflecting explicit configuration state, the telemetry data 166 may reflect inferred behavioral patterns and usage context that may be used by the machine learning models 180 to generate preference data 156 and predictive configuration recommendations 157, as further described with respect to FIGS. 2 and 3.

The data model system 111 may refer to a computational system configured to train and execute one or more machine learning models 180 using training data 175. The training data 175 may include, for example, user profiles 160 aggregated across numerous subscribers of the carrier network, as well as user activity records 165 reflecting historical device usage patterns, application interaction data, telemetry data 166, and configuration preferences over time associated with the current user, numerous other users, and/or users with common behavioral profiles. The machine learning models 180 may be trained to identify correlations between user activity records 165, telemetry data 166, device configuration parameters 130, preference data 156, and application usage patterns across the carrier network user base. Based on these correlations, the machine learning models 180 may generate predictive configuration recommendations 157 identifying applications likely to be of interest to a given user, together with recommended placement locations on the display interface of the target device 109. The data model system 111 may transmit the predictive configuration recommendations 157 to the profile management server 145 for storage in the user profile 160 in association with preference data 156 derived from the device configuration parameters 130 and user activity records 165.

The target device 109 may refer to a mobile device to which the user profile 160 is to be deployed during a device activation event. In an embodiment, the target device 109 is not limited to mobile handsets, but may refer to any intelligent or internet-connected device capable of receiving and applying the user profile 160, including telecom devices, smart televisions, smart home devices (e.g., smart speakers, home hubs, and home internet gateways), tablets, smartwatches, and other devices capable of communicating with the carrier network system 106 and applying configuration parameters 130 derived from the device-agnostic configuration schema 133. In this manner, the cross-device user experience migration system 100 may enable a user to propagate their personalized device experience not only across mobile handsets, but also across the full ecosystem of intelligent devices with which the user's handset interacts. As shown in FIG. 1, the target device 109 may include a deployment application 141, one or more settings modules 142, other installed applications 143, a local data store 127, and target-specific configuration parameters 144. The deployment application 141 may refer to a software application associated with the carrier application 115 and configured to retrieve the user profile 160 from the profile management server 145 upon detection of a carrier provisioning signal at the target device 109. In an embodiment, the deployment application 141 may translate the device-agnostic configuration schema 133 encoded in the user profile 160 into target-specific configuration parameters 144 compatible with the hardware configuration and software configuration of the target device 109, and may apply those parameters to the settings modules 142 of the target device 109 prior to completion of the native device setup procedure. The local data store 127 of the target device 109 may store the user profile 160 and translated target-specific configuration parameters 144 received from the profile management server 145. Upon completion of the configuration migration, the deployment application 141 may present the predictive configuration recommendations 157 to the subscriber, identifying suggested applications and their recommended spatial placement on the display interface of the target device 109.

Turning now to FIG. 2, shown is a diagram illustrating a method 200 for obtaining device configuration parameters 130 from a source device 103, storing a settings file 129 with the device configuration parameters 130 at the carrier network system 106, and generating preference data 156 using the device configuration parameters 130 indicated in the settings file 129. In particular, method 200 may be performed by the carrier application 115 executing at the source device 103, the management application 148 executing at the profile management server 145, and the data model system 111. Method 200 may begin at the source device 103 and proceed through a series of operations that culminate in the storage of preference data 156 in the user profile 160 maintained by the profile management server 145.

Method 200 may begin with operation 201, in which the carrier application 115 is invoked at the source device 103. At operation 203, the carrier application 115 may invoke system-level permissions to access the settings modules 121 of the source device 103. As described above, these system-level permissions may place the carrier application 115 in a privileged system application permission tier, enabling it to directly interrogate each of the settings modules 121. The settings modules 121 accessible at this step may include, for example, a display settings module, an application management module, an accessibility settings module, a notification management module, and a communications settings module.

At operation 205, the carrier application 115 may obtain device configuration parameters 130 from each of the settings modules 121. For example, the carrier application 115 may invoke system-level APIs to extract, receive, or capture the device configuration parameters 130 maintained by each of the settings modules 121. The device configuration parameters 130 obtained in this step may include, for example, application spatial placement data, display configuration settings, accessibility configurations, notification preferences, and communications settings, among others. In an embodiment, the carrier application 115 may query each of the settings modules 121 by issuing system-level API calls that are permitted only at the privileged permission tier, such as calls to a Settings Content Provider, an enrollment API, or equivalent system-level interfaces on other operating system platforms. Each API call may return a structured response comprising parameter keys and associated parameter values maintained by the queried settings module, which the carrier application 115 may parse and aggregate into a unified parameter set for encoding into the device settings file 129. Because the carrier application 115 operates at the privileged permission tier, the carrier application 115 may capture a more complete set of device configuration parameters 130 than may be achievable by third-party migration applications operating at the standard permission tier.

At operation 207, the carrier application 115 may store the device configuration parameters 130 into a device settings file 129 according to the device-agnostic configuration schema 133. The device-agnostic configuration schema 133 may encode the device configuration parameters 130 in a normalized, structured format that is independent of the operating system version, manufacturer-specific software layer, and hardware configuration of the source device 103. For example, the carrier application 115 may apply a predefined mapping table that translates platform-specific parameter keys — such as operating system-native setting identifiers — into standardized schema-defined parameter identifiers that are recognized across all device types within the carrier network ecosystem. Each device configuration parameter 130 may be encoded as a standardized configuration record comprising a schema-defined parameter identifier, a normalized parameter value, a parameter category, and/or, where applicable, a spatial placement attribute. In an embodiment, the carrier application 115 may perform value normalization during encoding — for example, converting platform-specific enumeration values such as display brightness levels or font size designations into standardized numerical scale values — such that the resulting device settings file 129 may be parsed and applied by the deployment application 141 at any target device 109 without requiring platform-specific decoding logic at the target device 109. In this manner, the device settings file 129 may serve as a portable, manufacturer-neutral representation of the device experience of the source device 103 that may be subsequently translated into target-specific configuration parameters 144 compatible with any target device 109 within the carrier network ecosystem.

At operation 209, the carrier application 115 may transmit the device settings file 129 to the profile management server 145. The carrier application 115 may transmit the device settings file 129 periodically, intermittently, or upon detecting that a threshold number of device configuration parameters 130 have changed since a prior transmission, thereby reducing unnecessary network transmission overhead. Upon receipt of the device settings file 129, the management application 148 at the profile management server 145 may proceed to operation 212.

At operation 212, the management application 148 may store the device settings file 129 in the user profile 160 associated with the user of the source device 103 in the carrier data store 151. The management application 148 may associate the device settings file 129 with the corresponding user profile 160 and may update the user profile 160 to reflect the most recently received device configuration parameters 130. In some embodiments, the user profile 160 may aggregate device settings files 129 from multiple devices associated with the user over time, maintaining a continuously updated record of the user's device experience across their full device history.

At operation 215, the data model system 111 may train one or more machine learning models 180 using training data 175 received at some point before operation 215. The training data 175 may include, for example, user profiles aggregated across numerous users of the carrier network, as well as the current user activity record 165. The machine learning models 180 may be trained (in some cases, well before method 300 executes) to identify correlations between user activity records, device configuration parameters, preference data, and/or application usage patterns across the carrier network user base, enabling the models 180 to generate predictions tailored to a given user.

At operation 218, the management application 148 may pass the device settings file 129 and a current user activity record 165 associated with the user to the data model system 111. The user activity record 165 passed at operation 218 may include telemetry data 166 comprising on-device behavioral telemetry, network and billing layer telemetry, and, in some embodiments, advertising intelligence signals, collectively providing the machine learning models 180 with a multi-source behavioral signal set that supplements the device configuration parameters 130 captured by direct settings interrogation. The user activity record 165 may reflect the user's historical device usage patterns, application interaction data, and/or configuration preferences over time. At operation 219, the data model system 111 may run one or more of the trained machine learning models 180 against the user activity record 165 and device settings file 129 associated with the user to obtain preference data 156. The preference data 156 may reflect inferred qualities or characteristics of the user derived from their device configuration parameters 130 and usage history. For example, the device configuration parameters 130 may indicate a volume preference indicator derived from sound level settings, a visual accessibility preference indicator derived from font size or display contrast settings, or an interest category preference indicator derived from folder names or application groupings on the display interface of the source device 103. The machine learning models 180 may further infer characteristics such as accessibility needs, general health considerations, or content interest categories based on patterns identified across the training data 175, to obtain the preference data 156.

At operation 221, the management application 148 may store the preference data 156 in the user profile 160 in the carrier data store 151. The preference data 156 stored at this step may be associated with the user profile 160 and may be made available to the data model system 111 for use in generating predictive configuration recommendations 157, as further described with respect to FIG. 3. In this manner, method 200 may result in a user profile 160 that reflects both the device experience of the source device 103 — encoded in the device settings file 129 — and the inferred preferences of the user derived by the machine learning models 180, collectively enabling the profile management server 145 to deploy a richer and more personalized configuration to the target device 109 during a subsequent device activation event.

Referring now to FIG. 3, shown is a message sequence diagram illustrating a method 300 for deploying a user profile 160 to a target device 109 according to various embodiments of the disclosure. In particular, method 300 may illustrate communications between the carrier application 115 executing at the source device 103, the management application 148 executing at the profile management server 145, and the deployment application 141 executing at the target device 109. Method 300 may build upon method 200 of FIG. 2, and may result in the deployment of the user profile 160 — including target-specific configuration parameters 144 and predictive configuration recommendations 157 — at the target device 109 prior to completion of the native device setup procedure.

Method 300 may begin with operation 301, in which the carrier application 115 transmits the device settings file 129 to the profile management server 145. The device settings file 129 transmitted at operation 301 may comprise device configuration parameters 130 organized according to the device-agnostic configuration schema 133, as generated during method 200. At operation 303, the management application 148 may store the device settings file 129 in the data store 151 in association with the user profile 160 corresponding to the user of the source device 103. The management application 148 may update the user profile 160 to reflect the most recently received device settings file 129, maintaining the user profile 160 as a living data structure that may be refreshed upon each new or modified transmission from the carrier application 115.

At operation 305, the data model system 111 may use one or more machine learning models 180 trained on training data 175 — which may include aggregated user profiles across the carrier network user base and the current user activity record 165 — to generate predictive configuration recommendations 157 associated with the user. The user activity record 165 used at operation 305 may include telemetry data 166, enabling the machine learning models 180 to incorporate passive behavioral signals — such as application launch frequency, session duration, and concurrent application usage patterns — in addition to device configuration parameters 130 when generating the predictive configuration recommendations 157. The predictive configuration recommendations 157 may identify one or more recommended application identities 309 corresponding to applications that may be considered interesting for a given user.

At operation 315, the management application 148 may supplement the user profile 160 with the predictive configuration recommendations 157 generated at operation 305. The updated user profile 160 may now comprise the device settings file 129, preference data 156 derived during method 200, and the predictive configuration recommendations 157, collectively representing a comprehensive and personalized record of the user's device experience and inferred preferences. The user profile 160 as supplemented at operation 315 may be stored in the data store 151 and may remain available for retrieval by the deployment application 141 upon detection of a device activation event at the target device 109.

At operation 318, the carrier network system 106 may receive a provisioning signal transmitted by the target device 109 upon initiation of an out-of-box experience (OOBE) procedure at the target device 109. For example, the provisioning signal may refer to a network registration request transmitted by the target device 109 to the carrier network system 106 upon initial power-on or SIM activation, by which the target device 109 identifies itself to the carrier network system 106 and requests network access and service provisioning. For example, the provisioning signal may comprise device identity information, SIM credentials, and/or an indication that the target device 109 is undergoing an initial activation procedure, enabling the carrier network system 106 to associate the target device 109 with the corresponding subscriber account and trigger deployment of the user profile 160. The provisioning signal may be triggered, for example, by activation of a SIM at the target device 109, which may cause the carrier network system 106 to associate the target device 109 with the user's subscriber account.

Upon detection of the provisioning signal at operation 318, the management application 148 may perform operation 310 to determine recommended placement locations 312 specifying where each recommended application may be placed on the display interface of the target device 109. For example, the recommended placement locations 312 may include a target display page identifier, a target grid position, and a target folder association. The management application 148 may supplement the predictive configuration recommendations 157 to include the recommended placement locations 312. In this manner, the predictive configuration recommendations 157 may reflect both the inferred application preferences of the user and a suggested spatial arrangement tailored to the display configuration of the target device 109. The management application 148 may leverage the machine learning models 180 trained on training data 175 at the data model system 111 to determine the recommended placement locations 312 based on patterns identified across aggregated user profiles and the current user activity record 165.

At operation 321, after the predictive configuration recommendations 157 have been updated, the management application 148 may retrieve the user profile 160 from the data store 151 and transmit it to the deployment application 141 at the target device 109. The deployment application 141 may receive the user profile 160 from the profile management server 145 and may store the user profile 160 in the local data store 127 of the target device 109 for subsequent processing.

At operation 324, the deployment application 141 may translate the device-agnostic configuration schema 133 encoded in the user profile 160 into target-specific configuration parameters 144 compatible with the hardware configuration and software configuration of the target device 109. The translation process may include remapping the application spatial placement data encoded in the device-agnostic configuration schema 133 to the display interface configuration of the target device 109. For example, where the display grid configuration of the target device 109 differs in dimensions from that of the source device 103, the deployment application 141 may regroup applications into folders, redistribute applications across display pages, or adjust individual grid positions to preserve spatial adjacency relationships between applications that were associated on the source device 103.

At operation 327, the deployment application 141 may apply the target-specific configuration parameters 144 to the settings modules 142 of the target device 109 prior to completion of the native device setup procedure. For example, the deployment application 141 may invoke system-level APIs at the target device 109 to write the target-specific configuration parameters 144 to each of the applicable settings modules 142, including the display settings module, application management module, accessibility settings module, notification management module, and/or communications settings module. By applying the target-specific configuration parameters 144 prior to completion of the native device setup procedure, the deployment application 141 may reproduce the device experience of the source device 103 at the target device 109 without requiring the user to manually re-enter configuration settings.

At operation 330, the deployment application 141 may present the predictive configuration recommendations 157 to the user at the target device 109. For example, the predictive configuration recommendations 157 may be displayed to the user as a list or visual arrangement of suggested applications, together with their recommended placement locations 312 on the display interface of the target device 109. The user may accept, modify, or dismiss individual recommendations, enabling the user to personalize the final configuration of the target device 109 while benefiting from the server-side predictive intelligence generated by the data model system 111. In this manner, method 300 may result in the near-instantaneous reproduction of the source device experience at the target device 109, supplemented by intelligent application recommendations, prior to completion of the native device setup procedure.

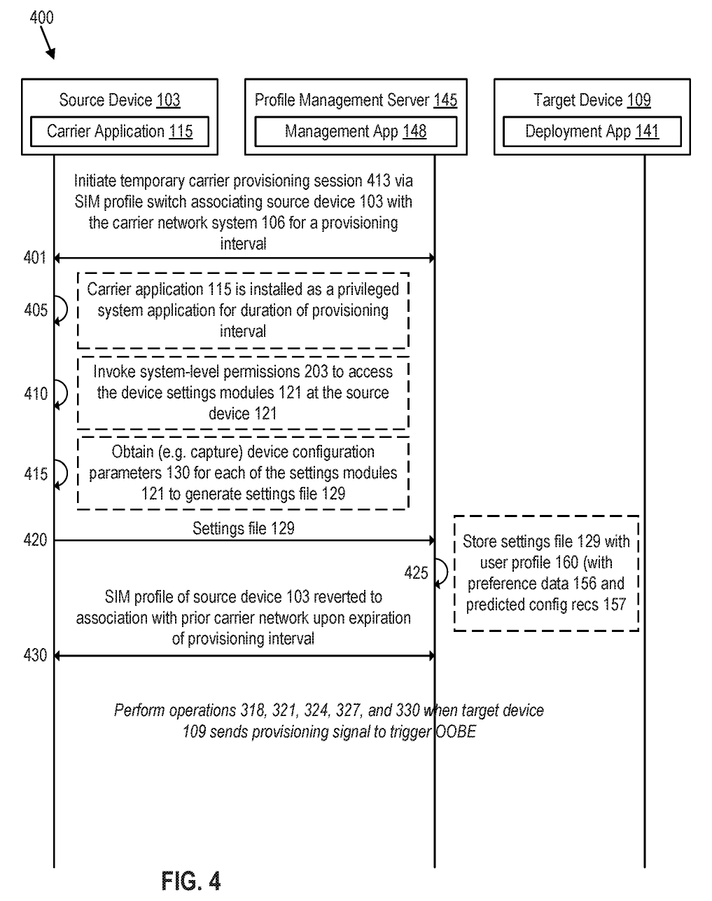

Turning now to FIG. 4, shown is a message sequence diagram illustrating a method 400 for initiating a temporary carrier provisioning session on a source device 103 associated with a non-carrier network and deploying a user profile 160 to a target device 109 according to various embodiments of the disclosure. Method 400 may be performed by the carrier application 115, the management application 148 executing at the profile management server 145, and the deployment application 141 executing at the target device 109. Method 400 may be applicable to scenarios in which the source device 103 is not already enrolled in the carrier network, such as when a user is transitioning from a competing carrier to the carrier network.

Method 400 may begin with operation 401, in which the carrier network system 106 initiates a temporary carrier provisioning session with the source device 103. The temporary carrier provisioning session may be initiated by performing a subscriber identity module profile switch that temporarily associates the source device 103 with the carrier network for a defined provisioning interval. For some devices, the carrier network system 106 may transmit a carrier profile activation signal to the source device 103 causing carrier software to execute at the foreground, enabling the carrier application 115 to access system-level permissions without physical replacement of the subscriber identity module. For other devices, the subscriber may be prompted to download a carrier profiling application to the source device 103 prior to the provisioning interval.

At operation 405, the carrier application 115 may be installed on the source device 103 as a privileged system application for the duration of the provisioning interval. This installation may place the carrier application 115 in the privileged system application permission tier, enabling it to access the settings modules 121 of the source device 103 in the same manner as described with respect to methods 200 and 300. At operation 410, the carrier application 115 may invoke system-level permissions to access the settings modules 121 of the source device 103. The carrier application 115 may interrogate each of the settings modules 121 using system-level APIs to capture the complete set of device configuration parameters 130 maintained by each module.

At operation 415, the carrier application 115 may obtain the device configuration parameters 130 from each of the settings modules 121 and generate a device settings file 129 organized according to the device-agnostic configuration schema 133, substantially as described with respect to method 200 of FIG. 2. The device settings file 129 may encode the device configuration parameters 130 in a normalized, structured format that is independent of the operating system version, manufacturer-specific software layer, and/or hardware configuration of the source device 103. At operation 420, the carrier application 115 may transmit the device settings file 129 to the profile management server 145.

At operation 425, the management application 148 may store the device settings file 129 in association with the user profile 160 of the corresponding subscriber in the carrier data store 151. The management application 148 may further supplement the user profile 160 with preference data 156 and predictive configuration recommendations 157 generated by the data model system 111, substantially as described with respect to methods 200 and 300. As part of this process, the management application 148 may pass the user activity record 165 — including telemetry data 166 collected by the carrier network system 106 — to the data model system 111, enabling the machine learning models 180 to generate preference data 156 and predictive configuration recommendations 157 informed by the subscriber's multi-source behavioral history. At operation 430, upon expiration of the provisioning interval, the carrier network system 106 may revert the SIM profile of the source device 103 to its prior association with the non-carrier network. In this manner, the temporary carrier provisioning session may impose no persistent modification on the source device 103, and the user profile 160 may remain stored at the profile management server 145 and available for deployment to the target device 109.

Upon the target device 109 transmitting a provisioning signal to trigger an OOBE procedure at the target device 109, method 400 may proceed with operations 318, 321, 324, 327, and 330 as described with respect to method 300 of FIG. 3. Specifically, the management application 148 may supplement the predictive configuration recommendations 157 with recommended placement locations 312, and transmit the updated user profile 160 to the deployment application 141 at the target device 109. The deployment application 141 may then translate the device-agnostic configuration schema 133 into target-specific configuration parameters 144, apply those parameters to the settings modules 142 prior to completion of the native device setup procedure, and present the predictive configuration recommendations 157 to the user at the target device 109.

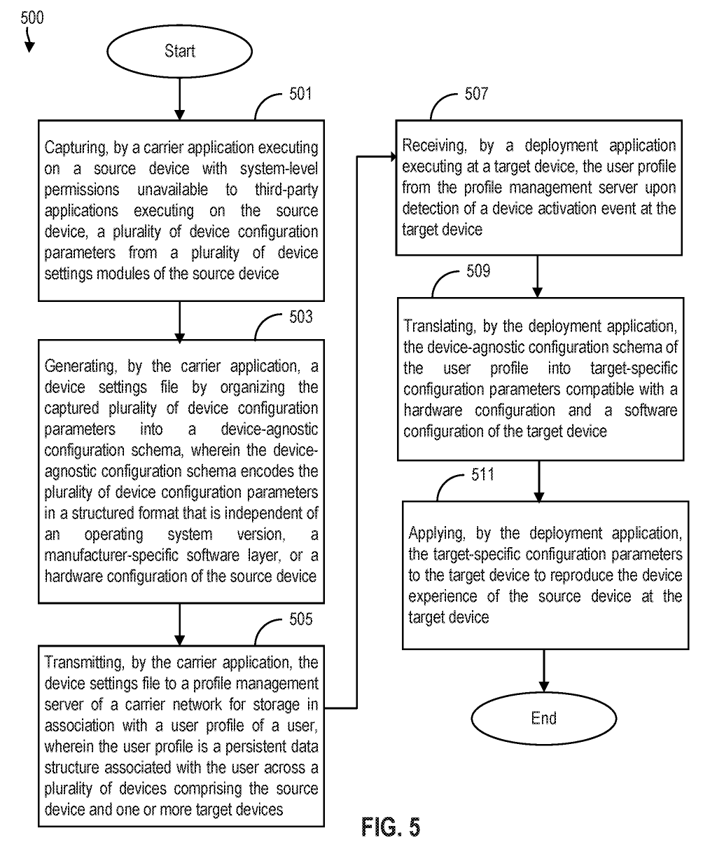

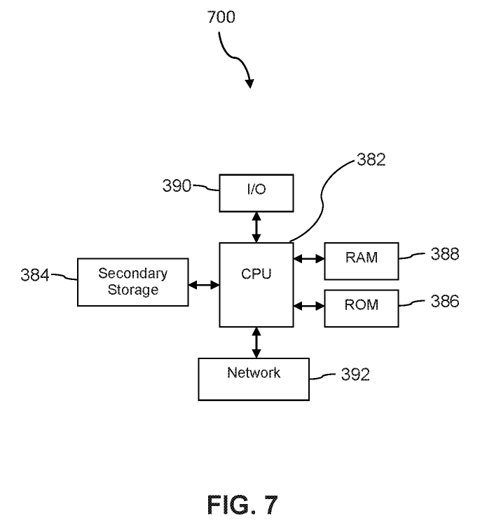

Turning now to FIG. 5, shown is a method 500 for cross-device user experience migration in a carrier network system according to an embodiment of the present disclosure. Method 500 may be performed by the carrier application 115 executing at the source device 103 and the deployment application 141 executing at the target device 109, in communication with the profile management server 145 of the carrier network system 106. In embodiments, method 500 may be implemented using a computer system with components as shown in FIG. 7. As illustrated, method 500 of FIG. 5 includes a number of enumerated operations, but embodiments of method 500 may include additional operations before, after, and in between the enumerated operations. In some embodiments, one or more of the enumerated operations may be omitted or performed in a different order.

At step 501, method 500 comprises capturing, by the carrier application 115 executing on the source device 103 with system-level permissions unavailable to third-party applications executing on the source device 103, a plurality of device configuration parameters 130 from a plurality of settings modules 121 of the source device 103. The carrier application 115 may invoke system-level APIs to interrogate each of the settings modules 121 and extract the device configuration parameters 130 maintained therein, including parameters that may be inaccessible to applications operating at the standard application permission tier.

At step 503, method 500 comprises generating, by the carrier application 115, a device settings file 129 by organizing the captured device configuration parameters 130 into a device-agnostic configuration schema 133. The device-agnostic configuration schema 133 may encode the device configuration parameters 130 in a normalized, structured format that is independent of the operating system version, manufacturer-specific software layer, or hardware configuration of the source device 103, enabling the device settings file 129 to serve as a portable, manufacturer-neutral representation of the device experience of the source device 103.

At step 505, method 500 comprises transmitting, by the carrier application 115, the device settings file 129 to the profile management server 145 of the carrier network system 106 for storage in association with a user experience profile 160 of the user. The user experience profile 160 may be a persistent data structure associated with the user across a plurality of devices comprising the source device 103 and one or more target devices 109, aggregating device settings files 129 derived from those devices over time.

At step 507, method 500 comprises receiving, by the deployment application 141 executing at the target device 109, the user experience profile 160 from the profile management server 145 upon detection of a device activation event at the target device 109. The device activation event may comprise an OOBE procedure triggered by detection of a carrier provisioning signal transmitted by the carrier network system 106 upon activation of a SIM at the target device 109.

At step 509, method 500 comprises translating, by the deployment application 141, the device-agnostic configuration schema 133 of the user experience profile 160 into target-specific configuration parameters 144 compatible with the hardware configuration and software configuration of the target device 109. The translation process may include remapping application spatial placement data to the display interface configuration of the target device 109, including redistributing applications across display pages or adjusting grid positions where the display configuration of the target device 109 differs in dimensions from that of the source device 103.

At step 511, method 500 comprises applying, by the deployment application 141, the target-specific configuration parameters 144 to the target device 109 to reproduce the device experience of the source device 103 at the target device 109. The deployment application 141 may apply the target-specific configuration parameters 144 prior to completion of the native device setup procedure, eliminating the need for manual reconfiguration by the user.

Method 500 may include other steps and features not otherwise shown in FIG. 5. In an embodiment, the carrier application 115 may transmit the device settings file 129 periodically or upon detecting that a threshold number of device configuration parameters 130 have changed since a prior transmission, reducing unnecessary network transmission overhead. In an embodiment, the device configuration parameters 130 captured at step 501 may include application spatial placement data defining, for each application 118 installed on the source device 103, at least one of a display page identifier, a grid position, or a folder association on the display interface of the source device 103. In an embodiment, the device configuration parameters 130 may further include home screen layout data, application tray configuration settings, display brightness settings, font size settings, magnification settings, sound level settings, volume profiles, notification preferences per application, default application assignments, battery optimization settings, lock screen configurations, wallpaper settings, and accessibility feature configurations.

In an embodiment, the carrier application 115 may apply a predefined mapping table to translate platform-specific parameter keys into standardized schema-defined parameter identifiers during generation of the device settings file 129 at step 503, enabling the deployment application 141 to parse and apply the device settings file 129 at any target device 109 without requiring platform-specific decoding logic. In an embodiment, the profile management server 145 may supplement the user experience profile 160 with preference data 156 derived from the device configuration parameters 130 using one or more machine learning models 180 of the data model system 111 prior to transmission of the user experience profile 160 to the deployment application 141 at step 507. In an embodiment, the user experience profile 160 retrieved at step 507 may further include predictive configuration recommendations 157 identifying one or more suggested applications and their recommended placement locations 312 on the display interface of the target device 109, which may be presented to the user upon completion of the configuration migration at step 511. In an embodiment, method 500 may be preceded by a temporary carrier provisioning session in which the carrier network system 106 performs a SIM profile switch that temporarily associates the source device 103 with the carrier network for a provisioning interval, enabling the carrier application 115 to be installed as a privileged system application and capture the device configuration parameters 130 at step 501 from a source device 103 associated with a non-carrier network.

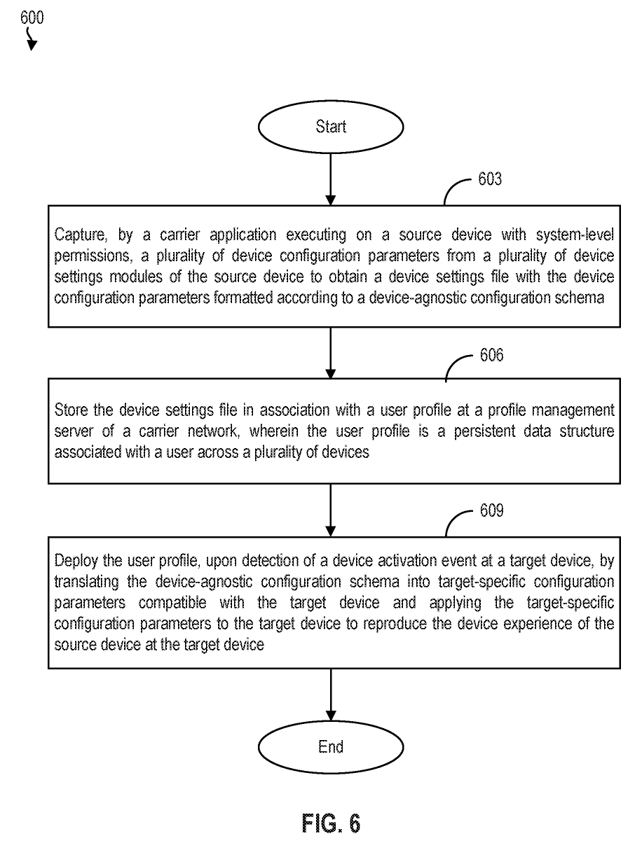

Turning now to FIG. 6, shown is a method 600 for cross-device user experience migration according to an embodiment of the present disclosure. Method 600 may be performed by one or more processors executing instructions stored on a non-transitory computer-readable medium, in communication with the source device 103, the profile management server 145, and the target device 109 of the carrier network system 106. In embodiments, method 600 may be implemented using a computer system with components as shown in FIG. 7. As illustrated, method 600 of FIG. 6 includes a number of enumerated operations, but embodiments of method 600 may include additional operations before, after, and in between the enumerated operations. In some embodiments, one or more of the enumerated operations may be omitted or performed in a different order.

At step 603, method 600 comprises capturing, by the carrier application 115 executing on the source device 103 with system-level permissions, a plurality of device configuration parameters 130 from a plurality of settings modules 121 of the source device 103 to obtain a device settings file 129 with the device configuration parameters 130 formatted according to a device-agnostic configuration schema 133. The carrier application 115 may invoke system-level APIs at the privileged permission tier to interrogate each of the settings modules 121 and organize the captured device configuration parameters 130 into the device-agnostic configuration schema 133, encoding them in a normalized, structured format independent of the operating system version, manufacturer-specific software layer, or hardware configuration of the source device 103.

At step 606, method 600 comprises storing the device settings file 129 in association with a user experience profile 160 at the profile management server 145 of the carrier network system 106. The user experience profile 160 may be a persistent data structure associated with the user across a plurality of devices, aggregating device settings files 129 derived from each of those devices over time, and maintained as a living data structure that may be updated upon each new or modified device settings file 129 transmission.

At step 609, method 600 comprises deploying the user experience profile 160, upon detection of a device activation event at the target device 109, by translating the device-agnostic configuration schema 133 into target-specific configuration parameters 144 compatible with the target device 109 and applying the target-specific configuration parameters 144 to the target device 109 to reproduce the device experience of the source device 103 at the target device 109. The deployment application 141 may apply the target-specific configuration parameters 144 to the settings modules 142 of the target device 109 prior to completion of the native device setup procedure, eliminating the need for manual reconfiguration by the user.

Method 600 may include other steps and features not otherwise shown in FIG. 6. In an embodiment, the device-agnostic configuration schema 133 may be independent of the operating system version, manufacturer-specific software layer, or hardware configuration of the source device 103. In an embodiment, the device configuration parameters 130 captured at step 601 may comprise application spatial placement data defining, for each application 118 installed on the source device 103, at least one of a display page identifier, a grid position, or a folder association on the display interface of the source device 103, and deploying the user experience profile 160 at step 605 may comprise remapping the application spatial placement data to the display interface configuration of the target device 109. In an embodiment, the device activation event at step 605 may comprise an OOBE procedure triggered by a carrier provisioning signal transmitted by the carrier network system 106 upon activation of a SIM at the target device 109, and deploying the user experience profile 160 may be performed prior to completion of the native device setup procedure executing at the target device 109.

In an embodiment, method 600 may further comprise initiating a temporary carrier provisioning session on a source device 103 associated with a non-carrier network by performing a SIM profile switch that temporarily associates the source device 103 with the carrier network for a provisioning interval, installing the carrier application 115 on the source device 103 as a privileged system application during the provisioning interval to enable capture of the device configuration parameters 130 at step 601, and reverting the SIM profile of the source device 103 to its prior association with the non-carrier network upon expiration of the provisioning interval. In an embodiment, method 600 may further comprise generating, using one or more machine learning models 180 executing in communication with the carrier network system 106, a predictive configuration recommendation 157 based on the user experience profile 160. The predictive configuration recommendation 157 specifies, for one or more suggested applications, a recommended application identity and a recommended placement location 312 on the display interface of the target device 109. In an embodiment, the user experience profile 160 may further be associated with one or more secondary ecosystem devices of a different form factor than the source device 103, comprising at least one of a tablet device, a smart television, or a home internet device, and deploying the user experience profile 160 at step 605 may comprise translating the device-agnostic configuration schema 133 into target-specific configuration parameters 144 compatible with the secondary ecosystem device.

FIG. 7 illustrates a computer system 700 suitable for implementing one or more embodiments disclosed herein. In an embodiment, source device 103, profile management server 145, and/or target device 109, etc., may each be implemented as the computer system 700. The computer system 700 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 700, at least one of the CPU 382, the RAM 388, and the ROM 386 are changed, transforming the computer system 700 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 700 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

In an embodiment, NFC may be employed to facilitate short-range, proximity-based data transfer between devices, such that a source device 103 embodied as the computer system 700 may transmit profile context data to a target device 109 embodied as the computer system 700 upon physical proximity or contact between the devices (e.g., a "tap" gesture). For example, a user may initiate a transfer of profile context by bringing the source device 103 into close proximity with the target device 109, causing the NFC-enabled radio transceiver cards of each device to establish a peer-to-peer NFC communication link over which the profile context data is exchanged. The target device 109 may comprise a mobile handset, a smart home device, or any other NFC-capable intelligent device configured to receive and apply the transmitted profile context..

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 700 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 700 to provide the functionality of a number of servers that is not directly bound to the number of computers in the computer system 700. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 700, at least portions of the contents of the computer program product to the secondary storage 384, to the ROM 386, to the RAM 388, and/or to other non-volatile memory and volatile memory of the computer system 700. The processor 382 may process the executable instructions and/or data structures in part by directly accessing the computer program product, for example by reading from a CD-ROM disk inserted into a disk drive peripheral of the computer system 700. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 700.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 700 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A system for cross-device user experience migration, wherein the system comprises:
a source device comprising a carrier application pre-installed on the source device that is configured to operate with system-level permissions assigned to the carrier application at a time of installation on the source device, wherein the system-level permissions enable the carrier application to access and interrogate a plurality of device settings modules of the source device, and wherein the carrier application is configured to:
capture a plurality of device configuration parameters from the plurality of device settings modules of the source device by invoking the system-level permissions;
generate a device settings file by organizing the captured plurality of device configuration parameters into a device-agnostic configuration schema, wherein the device-agnostic configuration schema encodes the plurality of device configuration parameters in a structured format that is independent of an operating system version, a manufacturer-specific software layer, or a hardware configuration of the source device; and
transmit the device settings file to a profile management server of a carrier network,
wherein the profile management server is configured to receive and store the device settings file in association with a user profile of a user, wherein the user profile is a persistent data structure associated with the user across a plurality of devices comprising the source device and one or more target devices, and wherein the user profile aggregates device settings files derived from the plurality of devices over time; and
a target device comprising a deployment application configured to:
retrieve the user profile from the profile management server;
translate the device-agnostic configuration schema of the user profile into target-specific configuration parameters compatible with a hardware configuration and a software configuration of the target device; and
apply the target-specific configuration parameters to the target device to reproduce a device experience of the source device at the target device.

2. The system of claim 1, wherein the profile management server is further configured to evaluate the device settings file to derive one or more user preference indicators describing inferred user preferences of a user of the source device, and wherein the user preference indicators are transmitted to the profile management server for storage with the user profile of the user.

3. The system of claim 1, wherein the plurality of device configuration parameters comprises application spatial placement data defining, for each application installed on the source device, at least one of: a display page identifier, a grid position, or a folder association on a display interface of the source device.

4. The system of claim 3, wherein, to translate the device-agnostic configuration schema of the user profile into the target-specific configuration parameters of the target device, the deployment application is configured to remap the application spatial placement data to a display interface configuration of the target device.

5. The system of claim 4, wherein remapping the application spatial placement data to the display interface configuration of the target device comprises at least one of: regrouping applications into folders, redistributing applications across display pages, or adjusting grid positions to preserve adjacency relationships between applications that were spatially associated on the source device, when the display interface configuration of the target device differs in dimensions from a display interface configuration of the source device.

6. The system of claim 1, wherein the deployment application is configured to retrieve the user profile and apply the target-specific configuration parameters to the target device prior to completion of a native device setup procedure executing at the target device upon initial activation of the target device.

7. A method for cross-device user experience migration in a carrier network system, wherein the method comprises:
capturing, by a carrier application executing on a source device with system-level permissions unavailable to third-party applications executing on the source device, a plurality of device configuration parameters from a plurality of device settings modules of the source device;
generating, by the carrier application, a device settings file by organizing the captured plurality of device configuration parameters into a device-agnostic configuration schema, wherein the device-agnostic configuration schema encodes the plurality of device configuration parameters in a structured format that is independent of an operating system version, a manufacturer-specific software layer, or a hardware configuration of the source device;
transmitting, by the carrier application, the device settings file to a profile management server of a carrier network for storage in association with a user profile of a user, wherein the user profile is a persistent data structure associated with the user across a plurality of devices comprising the source device and one or more target devices;
receiving, by a deployment application executing at a target device, the user profile from the profile management server upon detection of a device activation event at the target device;
translating, by the deployment application, the device-agnostic configuration schema of the user profile into target-specific configuration parameters compatible with a hardware configuration and a software configuration of the target device; and
applying, by the deployment application, the target-specific configuration parameters to the target device to reproduce the device experience of the source device at the target device.

8. The method of claim 7, wherein the device activation event comprises an out-of-box experience procedure at the target device triggered by detection of a carrier provisioning signal transmitted by the carrier network system upon activation of a subscriber identity module (SIM) at the target device, and wherein receiving the user profile is performed prior to completion of a native device setup procedure executing at the target device.

9. The method of claim 7, wherein the plurality of device configuration parameters captured from the plurality of device settings modules comprises at least one of: home screen layout data, application tray configuration settings, application spatial placement data defining a display page identifier, a grid position, and a folder association for each application on a display interface of the source device, font size settings, display brightness settings, magnification settings, sound level settings, volume profiles, notification preferences per application, default application assignments for at least one of a default browser, a default messaging application, or a default media application, battery optimization settings, lock screen configurations, wallpaper settings, or accessibility feature configurations.

10. The method of claim 9, wherein translating the device-agnostic configuration schema into target-specific configuration parameters comprises remapping the application spatial placement data to a display interface configuration of the target device by at least one of: regrouping applications into folders, redistributing applications across display pages, or adjusting grid positions to preserve adjacency relationships between applications that were spatially associated on the source device, when the display interface configuration of the target device differs in dimensions from the display interface configuration of the source device.

11. The method of claim 7, further comprising training, by a machine learning model executing in communication with the carrier network, on a plurality of user profiles aggregated across a plurality of users of the carrier network and on a current activity record associated with the user, to generate a predictive application recommendation identifying one or more applications that the user is predicted to be interested in based on patterns derived from the plurality of user profiles and the current activity record of the user.

12. The method of claim 11, wherein the predictive application recommendation specifies, for each of the one or more applications, a recommended application identity and a recommended placement location on a display interface of the target device, wherein the recommended placement location comprises at least a target display page identifier, a target grid position, and a target folder association, and wherein the predictive application recommendation is stored in association with the user profile and presented to the user upon deployment of the user profile to the target device.

13. The method of claim 7, further comprising:
initiating, by the carrier network, a temporary carrier provisioning session on the source device by performing a subscriber identity module profile switch that temporarily associates the source device with the carrier network for a provisioning interval;
installing, during the provisioning interval, the carrier application on the source device as a privileged system application to enable capture of the plurality of device configuration parameters from the plurality of device settings modules using the system-level permissions; and
reverting, upon expiration of the provisioning interval, the subscriber identity module profile of the source device to an association with a prior carrier network.

14. A non-transitory computer-readable medium comprising instructions that, when executed by one or more processors, cause the one or more processors to:
capture, by a carrier application executing on a source device with system-level permissions, a plurality of device configuration parameters from a plurality of device settings modules of the source device to obtain a device settings file with the device configuration parameters formatted according to a device-agnostic configuration schema;
store the device settings file in association with a user profile at a profile management server of a carrier network, wherein the user profile is a persistent data structure associated with a user across a plurality of devices; and
deploy the user profile, upon detection of a device activation event at a target device, by translating the device-agnostic configuration schema into target-specific configuration parameters compatible with the target device and applying the target-specific configuration parameters to the target device to reproduce the device experience of the source device at the target device.

15. The non-transitory computer-readable medium of claim 14, wherein device-agnostic configuration schema is independent of an operating system version, a manufacturer-specific software layer, or a hardware configuration of the source device.

16. The non-transitory computer-readable medium of claim 14, wherein the plurality of device configuration parameters comprises application spatial placement data defining, for each application installed on the source device, at least one of: a display page identifier, a grid position, or a folder association on a display interface of the source device, and wherein deploying the user profile comprises remapping the application spatial placement data to a display interface configuration of the target device.

17. The non-transitory computer-readable medium of claim 14, wherein the device activation event comprises an out-of-box experience procedure triggered by a carrier provisioning signal transmitted by a carrier network upon activation of a subscriber identity module at the target device, and wherein deploying the user profile is performed prior to completion of a native device setup procedure executing at the target device.

18. The non-transitory computer-readable medium of claim 14, wherein the instructions further cause the one or more processors to initiate a temporary carrier provisioning session on a source device associated with a non-carrier network by performing a subscriber identity module profile switch that temporarily associates the source device with the carrier network for a provisioning interval, install the carrier application on the source device as a privileged system application during the provisioning interval to enable capture of the plurality of device configuration parameters using the system-level permissions, and revert the subscriber identity module profile of the source device to an association with the non-carrier network upon expiration of the provisioning interval.

19. The non-transitory computer-readable medium of claim 15, wherein the instructions further cause the one or more processors to generate, using a machine learning model executing in communication with the carrier network, a predictive configuration recommendation based on the user profile, wherein the predictive configuration recommendation specifies, for one or more suggested applications, a recommended application identity and a recommended placement location on a display interface of the target device.

20. The non-transitory computer-readable medium of claim 14, wherein the user profile is further associated with one or more secondary ecosystem devices of a different form factor than the source device, comprising at least one of a tablet device, a smart television, or a home internet device, and wherein deploying the user profile comprises translating the device-agnostic configuration schema into target-specific configuration parameters compatible with the secondary ecosystem device.
